(19) United States
(12) Patent Application Publication
(10) Pub. No.: US 2008/0007390 A1
(43) Pub. Date: Jan. 10, 2008

(54) Vibrating silent alarm

(76) Inventors: Lance Wells, Ponca City, OK (US); Rana Wells, Ponca City, OK (US)

Correspondence Address: SUNG I. OH, PROFESSIONAL LAW CORPORATION, 710 QUAIL VALLEY LANE, WEST COVINA, CA, 91791, US

(21) Appl. No.: 11/482,002

(22) Filed: Jul. 6, 2006

(51) Int. Cl. H04B 3/36

(52) U.S. Cl. 340/407.1

(57) ABSTRACT

An alarm is worn on the wrist and vibrates to alert the wearer of a set time. The alarm includes a wrist strap that is fastened by hook-and-loop material and includes a padded cover that extends over the face of the device to protect the device.

### TECHNICAL FIELD OF THE INVENTION

The present invention relates to the general art of alarms, and to the particular field of wrist-worn alarm.

### BACKGROUND OF THE INVENTION

In numerous situations, it is useful to be able to transmit a piece of information to a person other than by acoustic or visual means. This is the case in particular when one wishes to alert a person who is in the middle of a meeting.

Quiet alarms of the described character have many important applications and uses. For example, such an alarm could be employed by one spouse to awaken at an early hour without disturbing the other spouse. An alarm of the described character could be employed by an incontinent individual, such as a young child having a bed-wetting problem, to awaken at a preselected time during the night without disturbing others in the surrounding area. A non-audible alarm may also be employed by the hearing impaired. A non-audible alarm can also be used to alert an elderly patient or a confused patient to take his or her medicine.

Conventional wrist watches having an alarm unit generally produce an alarm sound of various forms. Ordinarily, the wrist watch is made small in size, and it is difficult to mount therein a large battery which has a large current handling capacity and thus to produce a large acoustic sound. Therefore, unfortunately, such conventional wrist watches are convenient but the alarm sounds they produce tend to disturb other people near the wearers of the watch. This feature is inconvenient for a person who is working in a noisy area such as an airport, construction work area and so on. For a person who is working at a hospital, theater, a council chamber etc., where the noise is limited, it is also very inconvenient to use an acoustic sound electronic alarm wrist watch.

While the inventor is aware of several wrist worn devices that can be used to generate a silent alarm to the wearer, the inventor is not aware of any such devices that are easy and comfortable to wear and which also protect the device.

### SUMMARY OF THE INVENTION

The above-discussed disadvantages of the prior art are overcome by an alarm that is worn on the wrist and which vibrates to alert the wearer of a set time. The alarm includes a wrist strap that is fastened by hook-and-loop material and includes a padded cover that extends over the face of the device to protect the device.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a wrist-worn silent alarm embodying the present invention in the use condition.

FIG. 2 is a perspective view of a wrist-worn silent alarm embodying the present invention in the uncoiled condition.

### DETAILED DESCRIPTION OF THE INVENTION

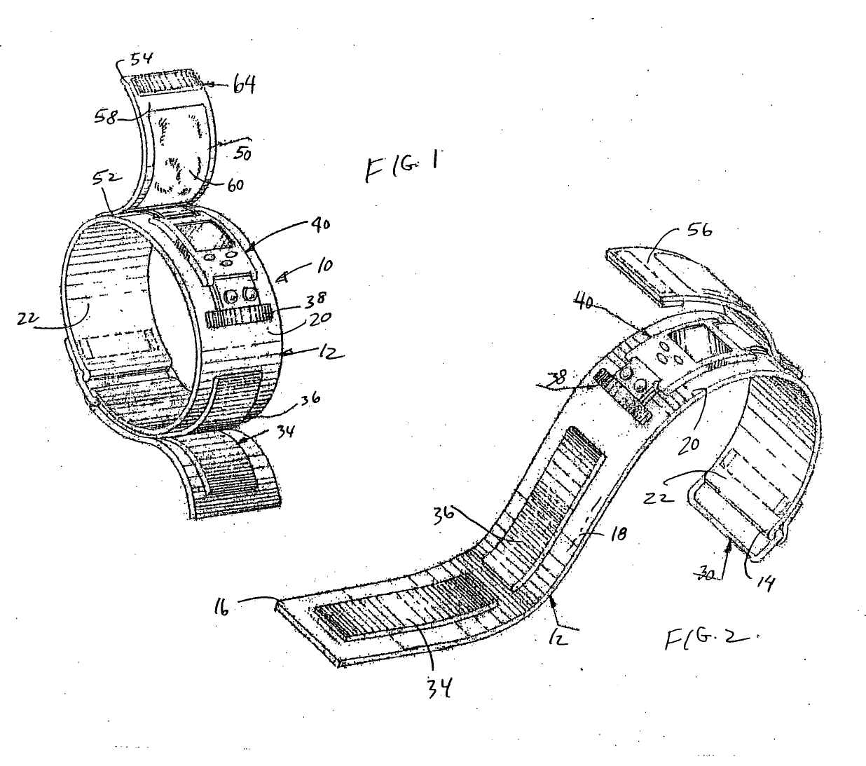

Referring to the figures, it can be understood that the present invention is embodied in a wrist-worn alarm unit 10 that will silently alert a wearer when a preset time is reached. Alarm unit 10 comprises a wrist strap 12 that will encircle a wearer's wrist when worn. The strap includes a first end 14, a second end 16 and a longitudinal axis 18 which extends between first end 14 and second end 16. Strap 12 can be formed of any suitable material. Strap 12 further includes a first surface 20 which is an outer surface when the strap is worn and a second surface 22 which is an inner surface when the strap is worn. It being noted that unit 10 is in the FIG. 1 configuration when worn.

A clasp 30 is fixed to first end 14 of the strap. Clasp 30 is sized and adapted to accommodate the strap adjacent to second end 16 as can be seen in FIG. 1 to attach the strap to the wrist of the wearer. Three portions of hook-and-loop fastener material, 34, 36 and 38 are located on first surface 20 of the strap. The three portions of hook-and-loop fastener material are spaced apart from each other in the direction of longitudinal axis 18 of the strap. As can be understood from FIG. 1, the first and second portions of hook-and-loop fastener material are located to releasably engage each other when the strap extends through the clasp on the first end of the strap.

A vibrating alarm mechanism 40 is mounted on first surface 20 of the strap. The circuits and components of vibrating alarm mechanism 40 are known to those skilled in the art. The details of the component parts of alarm mechanism 40 are not important to the present invention and thus will not be claimed or discussed.

A padded cover 50 is mounted on first surface 20 of the strap adjacent to vibrating alarm mechanism 40. Padded cover 50 includes a first end 52 which is fixed to the strap adjacent to the vibrating alarm mechanism, a second end 54, a first surface 56 that is an outer surface when the cover is in use and a second surface 58 that is an inner surface when the cover is in use.

A pad 60 is located on second surface 58, and a portion 64 of hook-and-loop fastener material is mounted on second surface 58 of padded cover 50 adjacent to second end 54 of the padded cover in position to cooperate with third portion 38 of hook-and-loop fastener material on first surface 20 of strap 12 to releasably lock cover 50 to the strap in position so pad 60 covers vibrating alarm mechanism 40 when hook-and-loop fastener material 64 of the padded cover releasably engages third portion 38 of hook-and-loop fastener material on the strap.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A wrist-worn alarm unit comprising:
A) a wrist strap that will encircle a wearer's wrist when worn, the strap including
(1) a first end,
(2) a second end,
(3) a longitudinal axis which extends between the first end and the second end,
(4) a first surface which is an outer surface when the strap is worn, and
(5) a second surface which is an inner surface when the strap is worn;
B) a clasp on the first end of the strap, the clasp being sized and adapted to accommodate the second end of the strap to attach the strap to the wrist of the wearer;
C) three portions of hook-and-loop fastener material on the first surface of the strap, the three portions being spaced apart from each other in the direction of the longitudinal axis of the strap, the first and second portions of hook-and-loop fastener material being located to releasably engage each other when the strap extends through the clasp on the first end of the strap;
D) a vibrating alarm mechanism mounted on the first surface of the strap; and
E) a padded cover mounted on the first surface of the strap adjacent to the vibrating alarm mechanism, the padded cover including
(1) a first end which is fixed to the strap adjacent to the vibrating alarm mechanism,
(2) a second end,
(3) a first surface that is an outer surface when the cover is in use,
(4) a second surface that is an inner surface when the cover is in use,
(5) a pad on the second surface, and
(6) a portion of hook-and-loop fastener material mounted on the second surface of the padded cover adjacent to the second end of the padded cover in position to cooperate with the third portion of hook-and-loop fastener material on the first surface of the strap to releasably lock the cover to the strap in position so the pad covers the vibrating alarm mechanism when the hook-and-loop fastener material of the padded cover releasably engages the third portion of hook-and-loop fastener material on the strap.

2. A wrist-worn alarm unit comprising:
A) a wrist strap that will encircle a wearer's wrist when worn;
B) a clasp on the strap, the clasp being sized and adapted to accommodate the strap to attach the strap to the wrist of the wearer;
C) a plurality of portions of hook-and-loop fastener material on the strap, the portions being spaced apart from each other, two of the portions of hook-and-loop fastener material being located to releasably engage each other when the strap extends through the clasp;
D) a vibrating alarm mechanism mounted on the strap; and
E) a padded cover mounted on the first surface of the strap adjacent to the vibrating alarm mechanism, the padded cover including
(1) a first end which is fixed to the strap adjacent to the vibrating alarm mechanism,
(2) a second end,
(3) a pad, and
(6) a portion of hook-and-loop fastener material which is located in position to cooperate with an associated portion of hook-and-loop fastener material on the strap to releasably lock the cover to the strap in position so the pad covers the vibrating alarm mechanism when the hook-and-loop fastener material of the padded cover releasably engages the associated portion of hook-and-loop fastener material on the strap.
